(19) United States
(12) Patent Application Publication
(10) Pub. No.: US 2005/0207808 A1
(43) Pub. Date: Sep. 22, 2005

(54) Apparatus and method for color toner separation

(76) Inventors: Uri Adler, Holon (IL); Serge Steinblatt, Ra'anana (IL); Yosef Kamir, Netanya (IL)

Correspondence Address: PEARL COHEN ZEDEK, LLP, 10 ROCKEFELLER PLAZA, SUITE 1001, NEW YORK, NY, 10020, US

(21) Appl. No.: 10/801,680

(22) Filed: Mar. 17, 2004

(51) Int. Cl. G03G 15/01

(52) U.S. Cl. 399/344

(57) ABSTRACT

An electrophotographic printing apparatus and method are provided to separate particles of at least one toner color from a mixture of colored toner particles. The toner separating apparatus may include a charging source, developer unit, and illumination unit that may illuminate a drum surface using one of more light wavelengths, after the developer has covered the drum surface with multi-color toner mixture. The printing apparatus may enable separation of a mixture of colored toner particles into the component colors, thereby enabling re-using of erased toner particles collected from previously erased colored images.

### FIELD OF THE INVENTION

The present invention relates to electro-photographic printing in general, and more particularly to an electro-photographic apparatus and method for enabling separation of selected colored toner particles from a mixture of color toner particles.

### BACKGROUND OF THE INVENTION

The color printing industry in general, and the laser printing, xerographic, electro-photographic technologies etc. have enabled tremendous amounts of printing to be rapidly produced. In some cases, these printing technologies may be used to print non-permanent images, for example, on printed display boards, as has been described in some embodiments in patent application Ser. No. 09/781,900, filed 13 Feb. 2001, titled “A METHOD AND SYSTEM FOR DISPLAYING AN IMAGE ON A SCREEN”, which is incorporated by reference herein in its entirety. In some cases no fusing process may be executed, and toner particles may be collected and re-used after having been used. In the case of colored printing, remaining or collected toner particles may include particles from a multitude of colors, providing a mixture of multi-colored toner particles.

It would be highly advantageous to have a system and/or method to enable separation of a mixture of multi-colored toner particles into its component colors, for example for re-usage of such toner particles.

### SUMMARY OF THE INVENTION

Embodiments of the present invention provide an apparatus and method to enable color-based toner particle separation from a mixture of colored toner particles. The toner separation apparatus may include for example a charging source, developer unit, and an illumination unit that illuminates a drum surface using one or more light wavelengths, after the developer has covered the drum surface with multi-color toner mixture.

The printing apparatus according to some embodiments may enable separation of a mixture of colored toner particles into the component colors, by charging a conductive drum surface, depositing toner particles on the drum surface, and subsequently illuminating the drum surface with a selected light wavelength. In this way selected color toner particles may be separated from other colored particles, thereby enabling re-use of erased toner particles collected from previously erased colored images.

### BRIEF DESCRIPTION OF THE DRAWINGS

The principles and operation of the system, apparatus, and method according to embodiments of the present invention may be better understood with reference to the drawings, and the following description, it being understood that these drawings are given for illustrative purposes only and are not meant to be limiting, wherein:

FIG. 1 is a schematic illustration of a printing drum used in a typical electro-photographic printing process;

FIG. 2 is a schematic illustration of an apparatus as used in a toner separation procedure, according to some embodiments of the present invention;

FIG. 3 is a close up schematic view illustrating the illumination of a selected wavelength of light onto a mixture of colored toner particles, according to some embodiments of the present invention;

FIG. 4 is a flow chart illustrating a method of separation a toner color from a mixture of toner colors, according to an embodiment of the present invention;

FIG. 5 is a flow chart illustrating a method of separation a plurality of toner colors from a mixture of toner colors, according to an embodiment of the present invention; and

FIG. 6 is a flow chart illustrating a method of toner color separation from a mixture of toner colors, according to an embodiment of the present invention.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals maybe repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

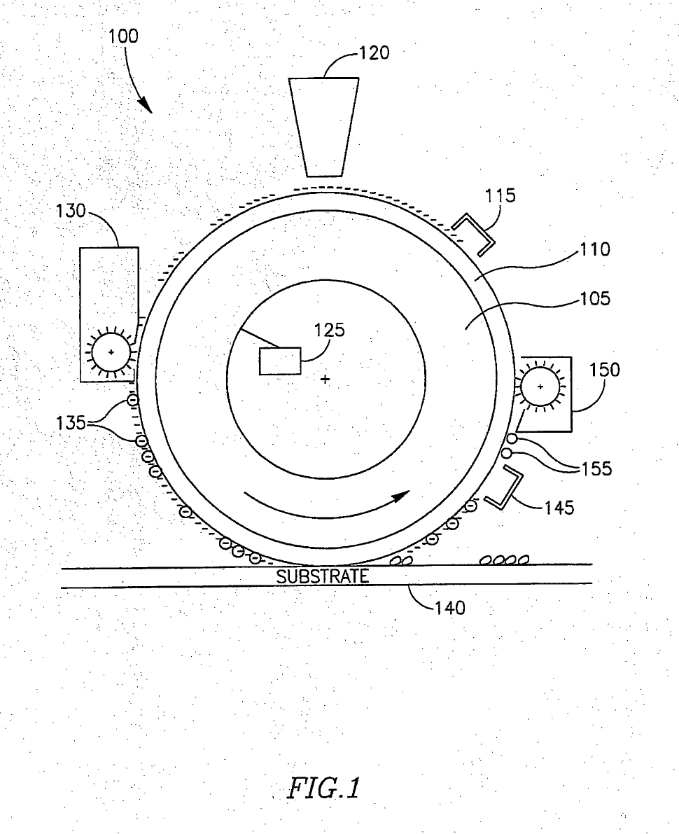

Electro-photographic printing methods are known in the art of digital printing. A typical process of implementing electro-photographic printing may be as follows, as can be seen with reference to FIG. 1. Other suitable systems and methods of printing and electro-photographic printing, using different components and systems, and different operations, may be used. An Organic Photo-Conductor (OPC) drum 100 may be used, which may consist of an electrically conductive drum 105, e.g. made of aluminum, covered by a photoconductive layer, for example, an Organic PhotoConductor (OPC) layer 10. The OPC layer 110 may have the property of being an electrical insulator when kept in the dark. At the spot(s) where it is exposed to and excited by light (in the correct wavelength range), it may become electrically conductive.

In a typical Electro-photographic printing process, the OPC drum 100 is charged with electrical charges, using a charging corona 115, an alternative charging device, or by another device or method. These charges are indicated by “−” (negative charges) in the figure. The OPC layer is represented in the following figures and descriptions as being charged with negative charges, although the various processes can be implemented by being charged positively. Typically, the OPC drum is charged at a potential of −600 V, however other voltages may be used.

The OPC layer 110 is subsequently imaged using an imaging head 120, such as a laser scanner or a LED array. The illuminated spots become conductive, and the charges that were present at those illuminated spots are neutralized or weakened. At those spots, the potential is typically between 0 V and −100 V, however other voltages maybe used. The charges which have been neutralized are transferred through the conductive drum 105, which is connected to ground or to a slightly positive voltage source 125. The areas that were not illuminated maintain the charge that was deposited by the charging corona 115. These areas constitute a latent image on the OPC drum 100.

It is well known that negatively charged particles in general, and negatively charged toner particles in particular, move in an electrical field. The direction of the movement of the negatively charged particles is from an element that is at a lower potential towards an element that is at a higher potential. For example, negatively charged particles will move from an element at a potential of 0 V towards an element at a positive potential of, for example, +100 V. Similarly, they will move from an element charged at a potential of −600 V towards an element at a potential of −300 V. Of course, other voltages maybe used.

The latent image may be developed by a developer 130 that “sprays” toner elements (such as plastic toner particles etc.) towards the OPC drum 100. The developer may be at an intermediate potential, between the potential of the illuminated and non-illuminated spots on the OPC, for example at −300V. The toner elements are typically negatively charged, such that the toner elements are attracted to and can readily adhere to the OPC layer in the places that have a higher potential than the developer, e.g. at −100V. Toner elements that have adhered to the OPC drum are indicated by a circle with a “−” inside, such as toner elements 135. The toner image is then transferred to the paper or film substrate 140. The substrate may be positively charged, or a positively charged drum may be used to attract the toner particles from the OPC drum surface.

It may occur that toner elements remain on the drum surface 110 after image transfer to the substrate 140. In such a case, the OPC drum surface may be reconditioned to prepare it for additional usage, by means of a conditioning corona 145, or an alternative charging device, or by another device or method. This device may neutralize or weaken the remaining charges, thereby making it easier to remove the remaining toner and thereby clean the drum. Toner elements associated with weaker or neutralized charges are represented by circles 155 on the surface of the drum between corona 145 and the cleaning station 150. The remaining toner is removed from the OPC drum 100 by a cleaning unit 150. Cleaning unit 150 may be positively charged to attract the negatively charged toner particles from the drum surface.

According to some embodiments of the present invention, a toner mixture, such as, for example, toner particles from a deleted substrate or toner cleaned off a printing drum etc., may be separated into component colors and optionally re-used for further printing. An example of a method for erasing a non-fused color image can be seen with reference to some embodiments in U.S. patent application Ser. No. 10/745,596, filed 29 Dec., 2003, titled, “APPARATUS AND METHOD FOR RECYCLING TONER IN A PRINTED IMAGE DISPLAY SYSTEM”, by the same inventors, which is hereby incorporated by reference in its entirety.

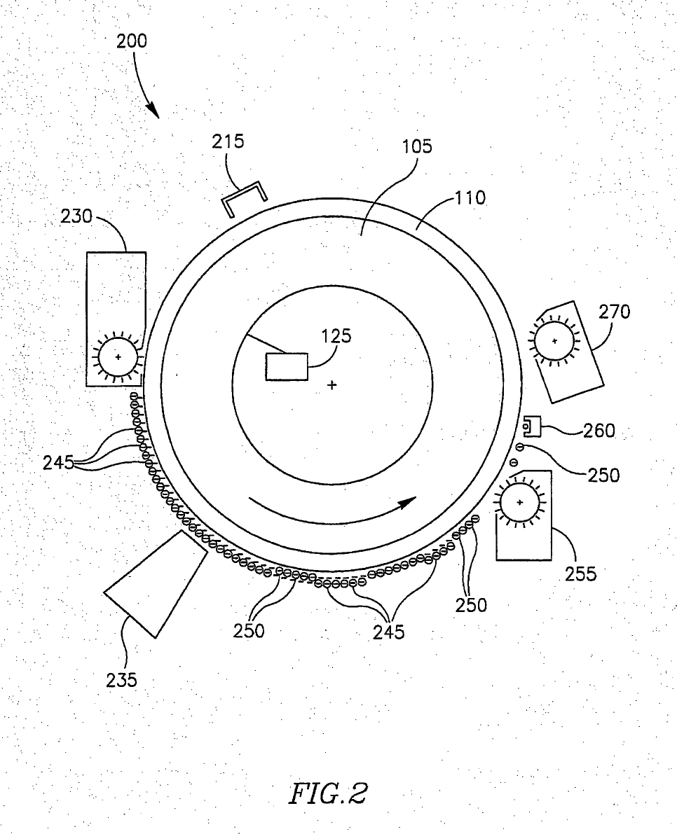

The components of an apparatus for enabling separation of mixed toner into component colors can be seen with reference to FIG. 2. The toner separation apparatus 200, according to some embodiments of the present invention; may include some or all of the following elements, as well as alternative suitable elements, in any combination.

Apparatus 200 may include an electrically conductive mechanism, such as a cylinder or drum 105. Drum 105 may typically be metal based, by an element such as aluminum; other suitable materials may be used.

Apparatus 200 may include a photoconductive layer 110 surrounding the drum surface, such as an OPC layer or another suitable layer. The OPC layer 110 may enable electrical insulation when kept in the dark, and may become electrically conductive at locations where it is excited by light (in the correct wavelength range).

Apparatus 200 may include at least one charging device 215, such as a charging corona, charged roller or any other charging device, to initially charge the drum 105 with electrical charge. The insulating layer may typically be charged with positive charges, although the apparatus 200 and toner separation process can work when charged negatively. Typically, the OPC drum may be charged at a potential of −300 V by the charging device 215, however, other voltages may be used.

Apparatus 200 may include at least one developer unit 230 for implementing the developer function, by depositing toner particles or elements on the drum surface 110. The developer may be charged at a lower potential that OPC drum 105, for example at −600 V, although other voltages may be used. Toner particles, for example, particles 245 and 250, which may include plastic toner elements or any other components that make up the toner content, are typically negatively charged, and are sprayed or otherwise distributed on the drum surface, as the developer is at a lower potential than the OPC drum However, the toner elements may alternatively be positively charged to ease the adhesion to negative charges on the drum surface 110. In the case of negatively charged toner, the conductive drum 105 may be charged, for example, to a positive potential of +300 for example to enhance the adhesion of the toner particles to the drum. Since in one embodiment no imaging process is implemented before development, according to some embodiments of the present invention, substantially all areas of the drum surface may be charged when applying development. Therefore the mixed toner particles in the developer 230 may adhere substantially evenly to the drum surface. Toner particles attached to negative charges are represented in the figure by circles 245 with a “−” inside on the ends of negative charges.

Apparatus 200 may include at least one imaging or illumination unit 235, such as a laser scanner, a LED array, or a white light source in conjunction with a color filter, etc. Illumination unit 235 may be used to illuminate the insulating layer 110 with at least one selective light wavelength, after the developer has covered the drum surface with multi-color toner mixture. The selected light wavelength may illuminate, for example, the entire drum surface 110, and may be transmitted through at least one toner color, such that illuminated spots underneath at least one toner color become conductive, and the charges that were present at those illuminated spots are neutralized or weakened. The charges maybe weakened through the conductive drum 105, which may be connected to for example ground or to a positive voltage source 125. Toner elements attached to neutralized or weakened charges, after illumination of the drum by illumination unit 235, are represented in the figure by circles with “−” inside 250 and without negative charges underneath. These toner elements may increase their adherence to the drum surface 110. Toner elements that absorb the light from illumination unit 235, for example 245, may maintain the same or a substantially similar charge underneath them as before the application of illumination. These toner elements may maintain their loose adherence to the drum surface 110.

Since light beams of particular wavelengths may discharge the charge under toner particles of particular colors, the illumination unit may be adapted to provide a plurality of colored light beams, for extraction of a plurality of color toners in the toner mixture. For example, a red light beam may be used to penetrate various color toner particles, while being absorbed into cyan toner particles only, thereby increasing the adherence of red transmitting particles to the drum surface relative to the cyan particles, and enabling extracting of cyan particles from a mixture of color toners. Alternatively or additionally, a plurality of illumination units maybe provided. Other suitable colors or wavelengths maybe used.

Apparatus 200 may include at least one first cleaning unit 255, which may include, for example, a brush or airflow unit or other suitable unit, etc., for cleaning off the toner elements 245 that are attached to a negative charge, for example, the toner particles of a particular color that may have absorbed the particular light wavelength transmitted from illumination unit 235. These toner particles, for example, may hardly adhere to the drum surface 110 at a position relatively-far from the developer 230, and may be easily cleaned off by cleaning unit 255.1In one embodiment, the positive voltage applied to the conductive drum 105 may be reduced or grounded, for example, to ease the cleaning of the particles 245 which are also naturally repelled by the negative charges under them. These toner particles that have been separated from the toner mixture may for example be collected and re-used for further printing.

Toner particles that did not absorb the light from illumination unit 235 but rather transmitted the light may remain attracted to the OPC drum surface, and may therefore adhere to the drum surface even after the cleaning of the drum surface by cleaning unit 255. Apparatus 200 may include at least one charging unit 260, for example, a conditioning corona (e.g., corona wire), charged roller or any other suitable charging device This device may neutralize or weaken the remaining charges, thereby making it easier to remove the remaining toner particles and thereby clean the OPC drum. In this way, the remaining toner particles 250 that maybe adhered to the drum surface 110 after cleaning unit 255 has removed toner particles 245, may be cleaned off the drum surface 110. This cleaning may be similar to the classical electro-photographic process, by using at least a second cleaning unit 270, which may include, for example, a brash or airflow unit or other suitable device etc., for cleaning off the remaining toner elements from the drum surface. At least one receptacle, such as a cartridge, optionally located within or outside of at least one of the cleaning units, may be used to receive and/or store collected toner elements. Collected toner elements may be re-used for further printing. In other embodiments re-use of toner need not be performed. For example, these particles, which may include a plurality of colored toner particles, according to one embodiment of the present invention, may be placed on apparatus 200 for further toner separation, or may be placed on a different toner separation apparatus for further separation. Of course, other structures and dimensions may be used.

An Electro-photographic method, according to some embodiments of the present invention, maybe used to extract at least a single toner from a mixture of colored toner particles. The following non-limiting example describes the separation of cyan (C) toner from a mixture of cyan, magenta, yellow and black (C, M, Y, K), or any other toner colors. The toner elements may be assumed to have their original toner properties, since they have typically not been fused. This mixture of non-fused toner elements may be obtained for example from the erasure of a non-fused color image. Other toner colors, or combinations of colors, maybe used and/or extracted.

Mixed toner elements, for example, including cyan, magenta, yellow and black (C, M, Y, K), such as those obtained for example from the erasure of a non-fused color image, may be collected in for example a toner receptacle or cassette. A conductive drum 105, such as an aluminum-covered drum, may be covered by an insulating layer, such as an Organic Photo-Conductor (OPC) layer. The OPC layer may be charged by a charging corona 215 or equivalent charging device. Other suitable materials maybe used.

OPC drum 200 may undergo development, by depositing toner elements from the toner cassette with mixed toner elements, for example, on top of an insulating layer, such as the OPC layer. For example, a mixture of cyan, magenta and yellow (C, M, Y) from the toner receptacle may be sprayed by developer 230 on to the charges on drum surface 110. The thickness of one layer of toner, for example, may be placed on the dram surface, as is typical in electro-photographic printing. Since typically no imaging has been implemented, charges may remain substantially evenly spread on the drum surface, thereby enabling toner elements to attach themselves to charges on substantially the whole drum surface.

OPC drum 200 may be illuminated by an illumination unit 235, which may include at least one single color light beam, such as, for example, a red light beam. A particular color beam may be generated according to the toner deletion requirements, since each toner color may substantially absorb a color light, which other toner colors may substantially transmit. For example, cyan toner has the property of absorbing red light. Accordingly, no light, or at least an attenuated quantity of light will reach an OPC covered drum under the cyan toner elements, since the cyan toner may typically absorb approximately 90% of the incident red light. On the other hand, the magenta and yellow toner elements are substantially transparent to red light, and may typically transmit approximately 90% of the incident red light.

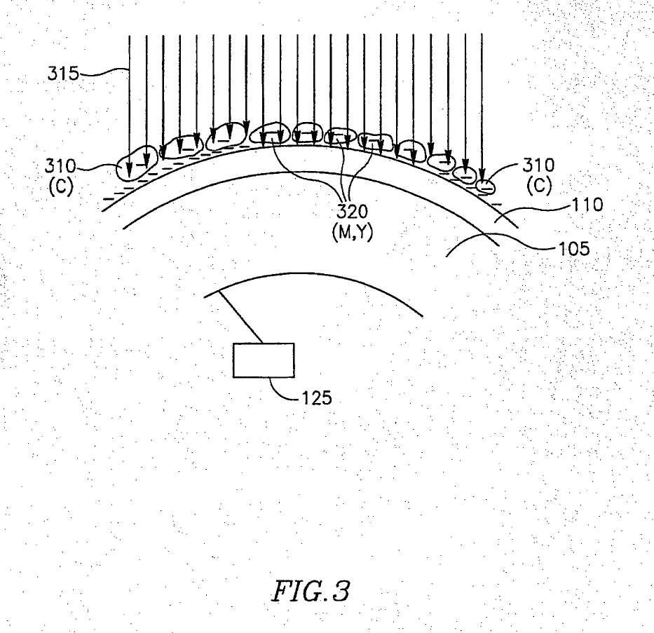

An example of the illumination of a selected light wavelength (e.g., red light) onto a mixture of colored toner particles, e.g., a C, M, and Y mixture, may be seen with reference to FIG. 3. As can be seen in FIG. 3, the cyan (C) toner elements 310 may substantially absorb the incoming red light 315, leaving the charges under the toner elements 310 substantially unchanged. In contrast, the magenta and yellow (M, Y) toner elements 320 may substantially allow the red light to pass through them or may otherwise not absorb much of the red light, thereby enabling the red light to neutralize or weaken the charges under the M and Y toner elements. The effect of the red light on the M and Y toner elements 320 may therefore be to enhance the adherence of these elements to the drum surface, by neutralizing the negative charges that tend to repel the toner elements from the OPC drum 105. In contrast, the C toner elements 310 may substantially absorb the red light, therefore preventing their charges from being substantially neutralized or weakened. This process may therefore result in weak bonds between the cyan toner elements and the charges on the drum surface. In this way the cyan may be separated from the CMY mixture. Similarly, the magenta toner may be separated from the MY mixture using green light, which is absorbed by the magenta toner but transmitted by the yellow toner.

In the general case where CMYK toners are used and the mixture of toners contains CMYK toner particle, the K toner may be separated first. Generally, it may be assumed that black absorbs all the components of white light; while cyan absorbs only red light; magenta absorbs only green light; and yellow absorbs only blue light etc. Black toner may, for example, be separated first, since it may absorb all color lights, while each of the C, M and Y toner particles etc. may transmit at least one of the color components of the white light. Any other toner colors and/or light beam colors, or combinations thereof, may be utilized for the toner separation processes described herein.

A preliminary cleaning step, by for example a first cleaning unit 255 (FIG. 2) may be implemented to remove the toner elements that are connected to a negative charge from drum 105. For example, according to the current example, the Cyan (C) elements 310 maybe removed relatively easily from drum surface, while the Magenta and Yellow (M and Y) elements 320 may withstand such a removal, as they are more substantially adhered to dram surface 105. A well known cleaning process may utilize a brush to clean the OPC drum. However any other suitable cleaning process may be implemented. The initial cleaning processes (e.g., by cleaning unit 255) should preferably be strong enough to substantially detach the required elements (e.g., C toner particles) from drum surface 110, but preferably gentle enough to substantially leave the non-required toner particles (e.g., M and Y toner particles), for example, on drum surface 110. Additionally or alternatively, an additional charging element, such as conditioning corona, maybe used to further weaken the adherence of the toner elements to the drum surface (not shown in the Figure).

According to some embodiments of the present invention, an airflow mechanism may be used to detach the toner elements from the OPC drum. The toner elements that may have been removed from the drum layer may be collected in a receptacle, such as a cartridge. Such a receptacle may be attached to the cleaning unit 255. Other detaching or cleaning elements or processes maybe used.

In some embodiments a charging device 260, such as a conditioning corona or charged roller, may be used to neutralize the charges remaining on drum surface 110, to recondition the OPC drum, and/or to neutralize the charges of the toner particles remaining on the drum surface, thereby weakening their adhesion to drum surface 110.

A second cleaning unit 270 may be used to clean off the remaining toner elements, for example, M and Y, from drum surface 110. The toner elements that may have been removed from the drum layer may be collected in a receptacle, such as a cartridge. Such a receptacle may be attached to the cleaning unit 270. Additional cleaning units maybe used.

Following the above process, one of the remaining toners, for example M, may be separated by implementing the above sequence for the remaining toner mixture (M, Y), in the same or an alternative separation apparatus 200. For example, a similar process may be implemented using green light, which is absorbed by magenta toner particles. In this case, for example, the green light may be absorbed by the magenta toner elements, while the yellow toner elements may allow the green light to be transferred through them, thereby neutralizing or weakening the charges under the yellow toner elements. Following the first and second cleaning processes, as outlined above, both remaining colors (magenta in the second cleaning unit and yellow in the first cleaning unit) may be transferred to toner cartridges and re-used for printing. The various light colors may easily be obtained by using a white light source, in conjunction with R, G, B filters etc., as is known in the art, or by any other means.

Any combination of the above steps may be implemented. Further, other steps or series of steps maybe used.

In another embodiment of the present invention one toner color may have magnetic properties unlike the other toner colors. For example, black toner may have magnetic properties unlike C, M, Y toners, etc. According to this embodiment, toner(s) with different magnetic properties may be separated from the other toners by using magnetic fields (using magnets or preferably electromagnets).

According to some embodiments of the present invention, it may be preferable to separate lighter colors before darker colors, to maintain relatively high toner color integrity and/or to aid in the prevention of toner color contamination. The yellow toner, for example, generally has a lower optical density than the other (darker) toners, and therefore its presence in the other toners may not significantly affect their color purity, in contrast to the presence of the other (non-yellow) toners in the yellow toner, which may significantly affect the color purity.

According to some embodiments of the present invention, after the extraction/separation of a toner color, the remaining toner mixture, extracted by the first cleaning unit, may be pumped or otherwise transferred to the developer 230 where a similar process may be implemented, using an alternative illumination unit to generate an alternative colored light beam. In such embodiments, illumination unit 235 maybe adapted to provide a plurality of light wavelengths, or a plurality of colored light beams. Additionally or alternatively, two or more illumination units may be integrated into the separation apparatus 200, to provide a plurality of color light beams. Alternatively, separate separation apparatuses 200 maybe used to separate various colors.

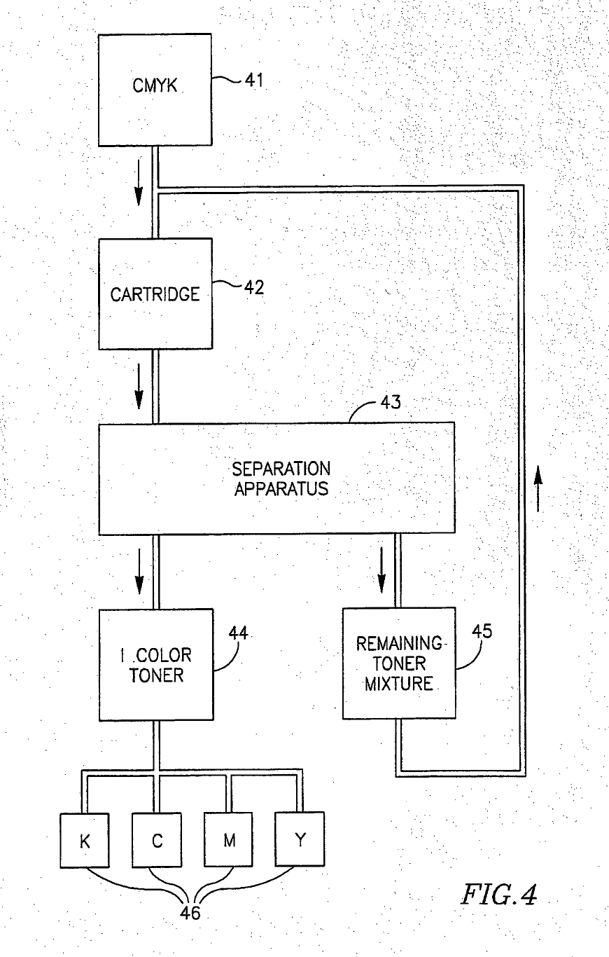

Reference is now made to FIG. 4, which illustrates a method for separating toner particles of at least one color from a mixture including toner particles of multiple colors. At block 41 mixed toner elements (for example, C, M, Y and K) may be a placed or collected in a receptacle. At block 42 these mixed toner elements may be placed in a toner cartridge operationally connected to a toner separation apparatus 200. At block 43 at least one color toner may be separated from the mixture of toner particles, using toner separation apparatus 200, as described above. At block 44 the particular color toner elements that have been removed from the toner mixture may be isolated. The particular toner particles may be, at block 46, placed in a suitable cartridge. At block 45 the remaining mixture of toner particles 45 may subsequently be transferred back into a receptacle, such as a toner cartridge, as at block 42. At block 43 the remaining toner mixture may then be processed by the toner separation apparatus 43 as described above, using an alternative light wavelength. This process may continue, using the same or different toner separation apparatuses, until some or all the component colors are separated. As can be seen in the figure, the order in which the single toner colors may be separated may be implemented from left to right, such that: black (K) is first, followed by cyan (C), magenta X and yellow (Y). Any alternative order may be followed. Other operations or series of operations maybe used.

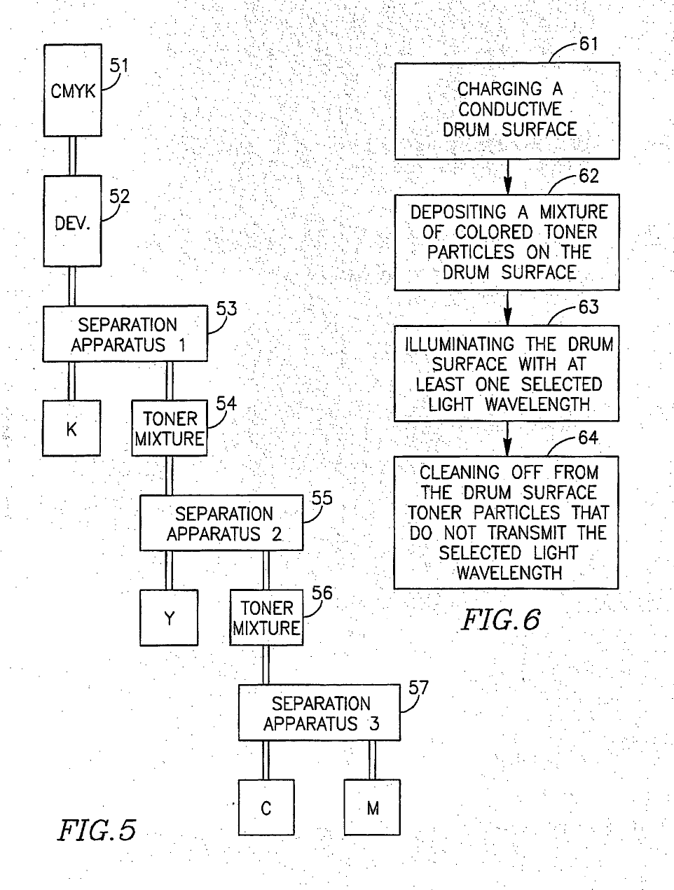

According to some embodiments of the present invention, several toner-separating apparatuses may be set up. Such a set up may enable operation of toner separating apparatuses in a continuum, such as a cascade or relay. Reference is now made to FIG. 5. At block 51 a receptacle containing mixed toner elements (for example, C, M, Y and K) may be collected. At block 52 the collected toner mixture may be placed in a toner cartridge associated with developer 230. At block 53 at least one toner color may be separated from the mixture using the toner separation apparatus 200 as described above. The toner color elements that have been removed from the toner mixture may be placed in a suitable receptacle or cartridge (e.g., K). At block 54 the remaining mixture may subsequently be transferred back into a receptacle, such as a toner cartridge. At block 55 the remaining toner mixture may then be processed by a second toner separation apparatus. At block 56 at least a second color toner may thereby be separated, and placed in a suitable receptacle or cartridge (e.g., Y). At block 57 the remaining toner mixture may be processed by a third toner separation apparatus. This process may continue, using the same or different toner separation apparatuses, until all the required component colors of the toner mixture are separated. As can be seen in FIG. 5, the order in which the single toner colors may be separated may be implemented from left to right, such that: black (K) is first, followed by yellow (Y), cyan (C) and magenta (M) etc. Any alternative order may be followed. Such embodiments may enable more efficient toner separation units, and may preventing toner contamination. Other operations or series of operations maybe used.

Reference is now made to FIG. 6, which illustrates a method for toner color separation, according to some embodiments of the present invention. At block 61 a conductive drum surface may be charged. At block. 62 a mixture of colored toner particles may be deposited on the drum surface. At block 63 the drum surface may be illuminated by at least one selected light wavelength. At block 64 toner particles that transmit the selected light wavelength may increase their adherence to the drum surface, and the toner particles that absorb the selected light wavelength may be cleaned off relatively easily from the drum surface by a cleaning unit.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall wit the true spirit of the invention.

1. An apparatus to enable color-based toner particle separation from a mixture of colored toner particles, comprising:
at least one charging source, to charge a photoconducting drum;
a developer unit to distribute toner elements on a surface of said drum; and
an illumination unit to provide at least one selected wavelength of light to said drum surface, said illumination unit being operated after said developer unit operates.

2. The apparatus of claim 1, comprising at least one cleaning unit, to clean off toner particles that are weakly adhered to said drum surface.

3. The apparatus of claim 1, wherein said illumination unit provides a plurality of light wavelengths.

4. The apparatus of claim 1, comprising a plurality of photconducting drums.

5. A method for separating particles of at least one color toner from a mixture of colored toner particles, the method comprising:
charging a conductive drum surface;
depositing a mixture of colored toner particles on said drum surface; and
illuminating said drum surface with at least one selected light wavelength, said illumination enhancing the adherence of toner particles that transmit said selected light wavelength.

6. The method of claim 5, further comprising cleaning off from said drum surface toner particles that do not transmit said selected light wavelength.

7. The method of claim 6, further comprising re-using cleaned off toner particles.

8. The method of claim 7, further comprising cleaning off from said drum surface a mixture of toner particles that transmit said selected light wavelength, and separating particles of at least one color toner from said mixture of toner particles cleaned off from said drum surface.

9. The method of claim 5, further comprising cleaning off from said drum surface the toner particles that transmit said selected light wavelength.

10. The method of claim 9, further comprising separating particles of at least one color toner from a mixture of colored toner particles that transmit said selected light wavelength.
